(19) United States
(12) Patent Application Publication
(10) Pub. No.: US 2005/0168588 A1
(43) Pub. Date: Aug. 4, 2005

(54) Methods and apparatuses for broadcasting information

(76) Inventors: Clay Fisher, San Diego, CA (US); Eric Edwards, San Jose, CA (US); Neal Manowitz, Montebello, NY (US); Robert Sato, San Diego, CA (US)

Correspondence Address: Valley Oak Law, 5655 Silver Creek Valley Road, #106, San Jose, CA, 95138, US

(21) Appl. No.: 10/771,818

(22) Filed: Feb. 4, 2004

(51) Int. Cl. H04N 5/232

(52) U.S. Cl. 348/211.2; 348/211.3

(57) ABSTRACT

In one embodiment, the methods and apparatuses detect a device within a predetermined area; detect an image captured by the device; determine a subject of the image based on the predetermined area; and broadcast a signal to the device wherein the signal describes the subject of the image.

### FIELD OF THE INVENTION

The present invention relates generally to broadcasting information and, more particularly, to broadcasting information to a device.

### BACKGROUND

There has been a proliferation of image capturing portable electronic devices utilized by users. These image capturing devices include cellular phones with image capturing modules, digital cameras, and video cameras. These image capturing devices are typically carried with the user and allow the user to conveniently capture image(s).

These image capturing devices are often utilized to capture images points of interest while traveling. For example, many images of the Golden Gate Bride, The White House, and other memorable sites are captured. The nature of electronic image capturing devices encourages users to capture many images of multiple subjects.

Often times, the image capturing device assigns an arbitrary file name to an image which has no relationship to the subject matter of the image. If the user desires annotations for each image based on the subject of each image, the user typically enters a descriptive file name and some descriptive key words for each image describing the subject of each image. The process of entering descriptive information is typically performed long after capturing the image and is tedious for the user. In some instances, based on the numerous captured images and diverse subject matter of these images, it is not possible for the user to remember all the details to effectively provide descriptive information for each image.

### SUMMARY

In one embodiment, the methods and apparatuses detect a device within a predetermined area; detect an image captured by the device; determine a subject of the image based on the predetermined area; and broadcast a signal to the device wherein the signal describes the subject of the image.

### BRIEF DESCRIPTION OF THE DRAWINGS

The accompanying drawings, which are incorporated in and constitute a part of this specification, illustrate and explain one embodiment of the methods and apparatuses for broadcasting information to a device. In the drawings,

FIG. 1 is a diagram illustrating an environment within which the methods and apparatuses for broadcasting information to a device are implemented;

FIG. 2 is a simplified block diagram illustrating one embodiment in which the methods and apparatuses for broadcasting information to a device are implemented;

FIG. 3 is a simplified block diagram illustrating a system, consistent with one embodiment of the methods and apparatuses for broadcasting information to a device;

FIG. 4 is an exemplary record for use with the methods and apparatuses for broadcasting information to a device;

FIG. 5 is a flow diagram consistent with one embodiment of the methods and apparatuses for broadcasting information to a device; and

FIG. 6 is a flow diagram consistent with one embodiment of the methods and apparatuses for broadcasting information to a device.

### DETAILED DESCRIPTION

The following detailed description of the methods and apparatuses for broadcasting information to a device refers to the accompanying drawings. The detailed description is not intended to limit the methods and apparatuses for broadcasting information to a device. Instead, the scope of the methods and apparatuses for broadcasting information to a device is defined by the appended claims and equivalents. Those skilled in the art will recognize that many other implementations are possible, consistent with the present invention.

References to “electronic device” and “device” include a device such as a video camera, a still picture camera, a cellular phone, a personal digital assistant, and an image capturing device.

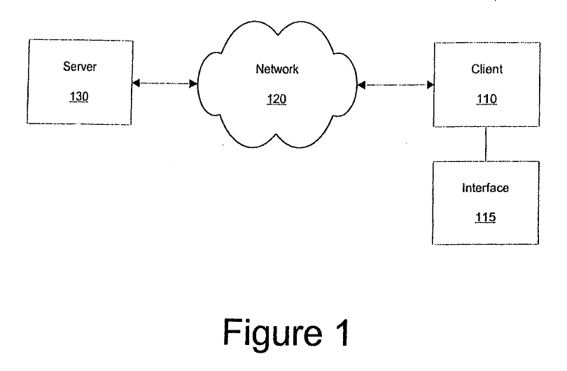

FIG. 1 is a diagram illustrating an environment within which the methods and apparatuses for broadcasting information to a device are implemented. The environment includes an electronic device 110 (e.g., a computing platform configured to act as a client device, such as a computer, a personal digital assistant, a digital camera, a video camera), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing as personal digital assistant electronics (e.g., as in a Clie® manufactured by Sony Corporation). In other embodiments, one or more user interface 115 components (e.g., a keyboard, a pointing device (mouse, trackball, etc.), a microphone, a speaker, a display, a camera are physically separate from, and are conventionally coupled to, electronic device 110. The user utilizes interface 115 to access and control content and applications stored in electronic device 110, server 130, or a remote storage device (not shown) coupled via network 120.

In accordance with the invention, embodiments of broadcasting information to a device below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

The methods and apparatuses for broadcasting information to a device are shown in the context of exemplary embodiments of applications in which information is broadcasted to the device based on the subject of the captured image. In one embodiment, the subject of the captured image is based on the location of the device while recording the captured image. In one embodiment, the information describing the subject is transmitted to the electronic device 110 through the network 120.

In one embodiment, the methods and apparatuses for broadcasting information to a device utilizes a record associated with the subject of the captured image. In one embodiment, the record includes details relating to the subject of the captured image such as the location of the subject, background information of the subject, related subjects, and key words describing the subject.

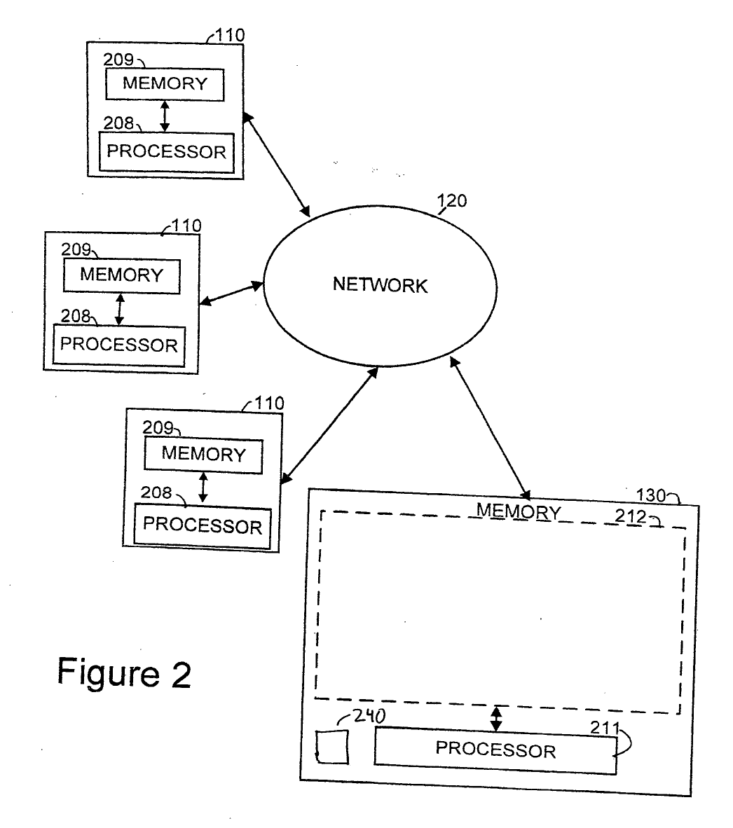

FIG. 2 is a simplified diagram illustrating an exemplary architecture in which the methods and apparatuses for broadcasting information to a device are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. A unique user operates each electronic device 110 via an interface 115 as described with reference to FIG. 1.

Server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

The plurality of client devices 110 and the server 130 include instructions for a customized application broadcasting information to a device. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on broadcasting information to a device as determined using embodiments described below.

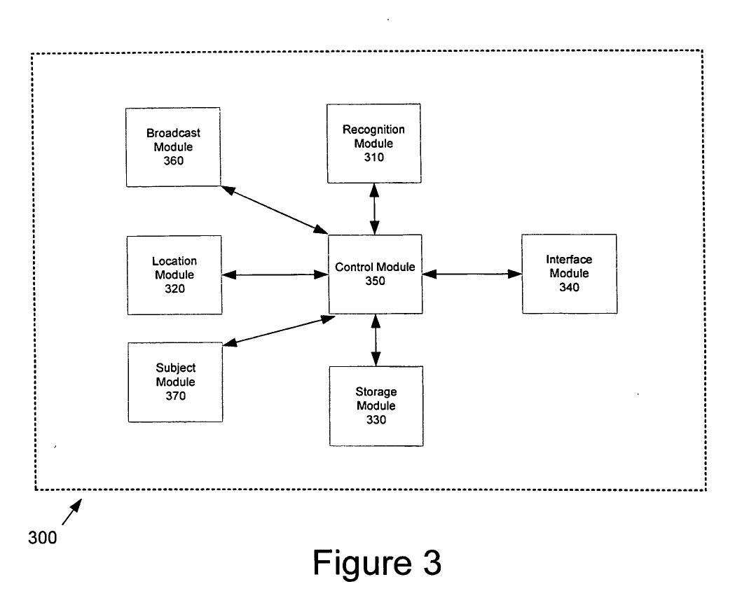

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a recognition module 310, a location module 320, a storage module 330, an interface module 340, a control module 350, a broadcast module 360, and a subject module 370.

In one embodiment, the control module 350 communicates with the recognition module 310, the location module 320, the storage module 330, the interface module 340, the broadcast module 360, and the subject module 370. In one embodiment, the control module 350 coordinates tasks, requests, and communications between the recognition module 310, the location module 320, the storage module 330, the interface module 340, the broadcast module 360, and the subject module 370.

In one embodiment, the recognition module 310 determines the type of device that is detected. For example, the different types of devices include cellular phones with cameras, digital still cameras, video cameras, and the like.

In one embodiment, the recognition module 310 senses the type of device by sensing the type of signal that is transmitted by the device. In another embodiment, the recognition module 310 senses the type of device by transmitting a signal to the device and receiving a confirmation from the device.

In one embodiment, the location module 320 detects the location of a device while the device captures an image. In one embodiment, the location module 320 detects whether the device is within a predefined area. For example, the predefined area includes a viewing area for an exhibit such as a painting inside a museum. In another example, the predefined area includes a viewing area for the Washington Monument.

In one embodiment, the location module 320 detects the direction that the device is pointing towards when the device captures an image. For example, the location module 320 detects that the device is aimed towards a particular object. In one instance, the location module 320 detects that the device is pointed towards the White House while the device captures an image.

In one embodiment, the location module 320 includes multiple sensors to detect the location of the device. In another embodiment, the location module 320 utilizes a cellular network to detect the location of the device. In yet another embodiment, the location module 320 utilizes a global positioning satellite system to detect the location of the device.

In one embodiment, the subject module 370 determines the subject of the captured image based on the location of the device while capturing the image. For example, if the device is located within a particular predetermined area and pointing in a particular direction while capturing an image, the subject module 370 determines the subject of the captured image based on the particular predetermined area and direction of the device.

In another embodiment, the subject module 370 determines the subject of the captured image based on matching the captured image with a reference image. In this embodiment, the reference image is stored within the storage module 330, and represents an exemplary image of a particular subject. For example, an exemplary reference image for the Golden Gate Bridge includes a picture of the Golden Gate Bridge from a common vantage point.

In one embodiment, the storage module 330 stores a record including metadata associated with a particular subject to be broadcasted to the device based on the location of the device while capturing an image. In another embodiment, the storage module 330 stores a unique identifier in place of the metadata which represents a particular subject. In yet another embodiment, the reference image is stored within the record with metadata.

In one embodiment, the interface module 340 receives a signal from one of the electronic devices 110. For example, in one instance, the electronic device transmits a signal identifying the device's type. In another embodiment, the interface module 340 transmits a signal to a device containing metadata. In yet another embodiment, the interface module 340 displays information contained within the record associated with the particular image that is captured by the device.

In one embodiment, the broadcast module 360 prepares the metadata with one of the records to be broadcasted to the device. In another embodiment, the broadcast module 360 prepares the unique identifier to be broadcasted to the device.

The system 300 in FIG. 3 is shown for exemplary purposes and is merely one embodiment of the methods and apparatuses for broadcasting information to a device. Additional modules may be added to the system 300 without departing from the scope of the methods and apparatuses for broadcasting information to a device. Similarly, modules may be combined or deleted without departing from the scope of the methods and apparatuses for broadcasting information to a device.

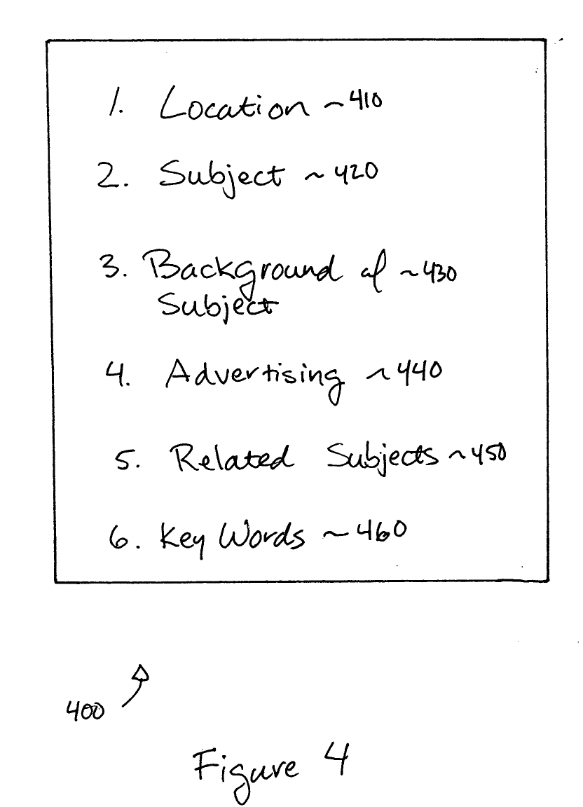

FIG. 4 illustrates an exemplary record 400 for use with the system 300. The record 400 is associated with an image captured in a specific location and of a subject. In one embodiment, the record 400 includes the metadata that is locally broadcasted to a device. Different portions of the broadcasted metadata that comprise a specific profile are described by the record 400. In one embodiment, the record 400 includes a location field 410, a subject field 420, a background of subject field 430, an advertising field 440, a related subjects field 450, and a key words field 460.

In one embodiment, the location field 410 indicates location information describing a particular location where an image was captured. For example, in one instance, the location field 410 within the record 400 includes a listing such as “San “Francisco, Calif.”, “Washington, D.C.”, and “New York, N.Y.”.

In one embodiment, the subject field 420 indicates subject information describing a particular subject matter of an image that was captured. For example, in one instance, the subject field 420 within the record 400 includes a listing such as “Golden Gate Bridge” associated with San Francisco, Calif., “The White House” associated with Washington, D.C., and “The Empire State Building” associated with New York, N.Y.

In one embodiment, the background field 430 indicates background information describing a particular subject matter of an image that was captured. For example, in one instance, the background field 430 within the record 400 includes a description of the historical background for items such as the Golden Gate Bridge, The White House, and the Empire State Building.

In one embodiment, the advertisement field 440 indicates an advertisement as part of the record 400 configured to be received by the device along with other information within the record 400. For example, in one instance, the advertisement field 440 within the record 400 includes a textual advertisement for a product and/or service. In another example, the advertisement field 440 within the record 400 includes a graphic intended to advertise a product and/or service.

In one embodiment, the related subjects field 450 indicates subjects related to the subject within the subject field 420. For example, in one instance, the subject field 420 within the record 400 includes a listing such as “Golden Gate Bridge”. In one embodiment, the related subjects field 450 includes a listing such as “Fisherman's Wharf” as a related subject to the Golden Gate Bridge.

In one embodiment, the key words field 460 indicates key word information describing a particular subject matter of an image that was captured. For example, in one instance, if the subject field 420 within the record 400 includes a listing such as Golden Gate Bridge, key words within the key words field 460 includes “San Francisco”, “bridge”, “water”, and “transportation” in one embodiment.

In another embodiment, the record 400 also includes a reference image that illustrates an exemplary image of a particular subject. In one embodiment, this reference image is utilized by the subject module 370 to identify the subject of the captured image by comparing the captured image with the reference image.

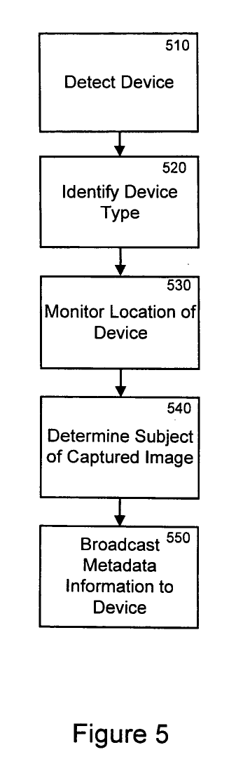

The flow diagrams as depicted in FIGS. 5, 6, and 7 are one embodiment of the methods and apparatuses for broadcasting information to a device. The blocks within the flow diagrams can be performed in a different sequence without departing from the spirit of the methods and apparatuses for broadcasting information to a device. Further, blocks can be deleted, added, or combined without departing from the spirit of the methods and apparatuses for broadcasting information to a device.

The flow diagram in FIG. 5 illustrates locally broadcasting metadata to a device according to one embodiment of the invention. In Block 510, an electronic device is detected. In one embodiment, the electronic device is a digital camera, a video camera, a personal digital device with an image capture module, and the like.

In one embodiment, the electronic device is detected by a sensor coupled to a network. For example, in one embodiment, the sensor is a cellular site coupled to a cellular network. In another embodiment, the sensor is a Bluetooth transmitter coupled to a local Bluetooth network. In yet another embodiment, the sensor is a Wi-Fi transmitter coupled to a Wi-Fi network.

In one embodiment, the electronic device is detected with a predetermined area such as a viewing area of The White House. In one instance, this predetermined area is customizable depending on the specific application. For example, a predetermined area with a view of the Golden Gate Bridge is predetermined by configuring the sensors to detect the electronic device.

In Block 520, the device type of the electronic device is detected. In one embodiment, different types of devices include cellular phones with image capture module, still cameras, video cameras, and the like.

In Block 530, the location of the device while capturing an image is monitored. In one embodiment, the sensor detects the location of the device when capturing the image by monitoring the device while within the predetermined area. For example, capturing the image by the device while the device is within the predetermined area is detected.

In one embodiment, the location of the device is monitored when the device captures the image. For example, the direction of the device is detected while the device is capturing the image. In one embodiment, the direction of the device is represented by minutes and seconds.

In Block 540, the subject matter of the image is determined. In one embodiment, the subject matter is determined based on the predetermined area that the device was located while capturing the image. In another embodiment, the subject mater of the image is determined also based on the direction of the device while capturing the image.

For example, the device is located within the predetermined area related to capturing images of The White House. In this example, the device is detected while within this predetermined area prior to capturing the image. In one embodiment, the device is detected within this predetermined area while capturing the image. In one embodiment, based on the device located within the predetermined area while capturing the image, the subject matter is determined to include The White House. In another embodiment, based on the device located within the predetermined area and the direction of the device when capturing the image, subject matter of the image is determined to include The White House.

In Block 550, metadata information is broadcasted to the device based on the location of the device while capturing the image. In one embodiment, the metadata information is locally broadcasted through a network such as a Wi-Fi network, a blue tooth network, a cellular network, and the like.

In one embodiment, the metadata information includes fields within the record 400. In one embodiment, the record 400 describes the image captured by the device and is associated with the device.

For example, in one embodiment, the device is detected within the predetermined area that is a viewing area to photograph the Golden Gate Bridge. The direction of the device is recorded while capturing an image. In this embodiment, based on the device within the predetermined area and the direction of the device while capturing the image, the subject matter of the image is determined as the Golden Gate Bridge. Further, the metadata information corresponding to the Golden Gate Bridge is broadcasted to the device.

In one embodiment, the metadata information labels the image with a descriptive name and provides background information about the subject matter of the image. In another embodiment, the metadata information provides an advertising opportunity based on interest in the subject matter and the geographical location of the subject matter and provides an opportunity to suggest related subject matter for capturing an image. In yet another embodiment, the metadata information categorizes the image based on key words.

In one embodiment, broadcasting the metadata information corresponding to the captured image is available through a paid service. For example, the metadata information is broadcasted through a third party. In one embodiment, payment for broadcasting the metadata information is made on a per use basis. In another embodiment, a monthly subscription is paid to broadcast the corresponding metadata information.

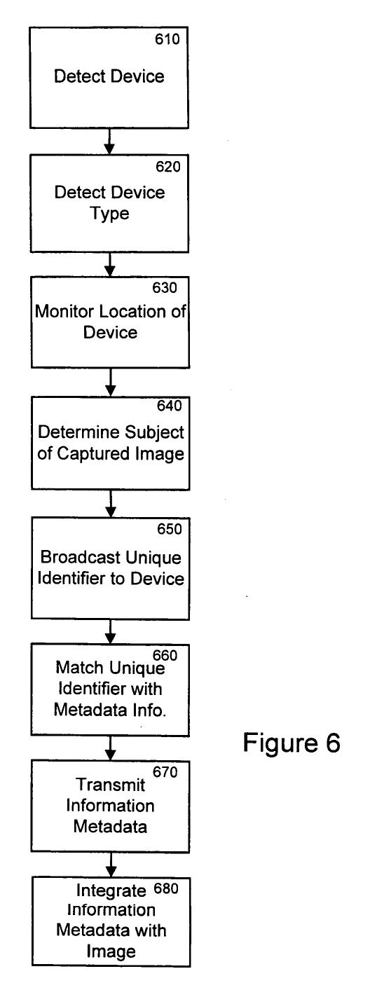

The flow diagram in FIG. 6 illustrates locally broadcasting information to a device according to one embodiment of the invention. In Block 610, an electronic device is detected. In one embodiment, the electronic device is a digital camera, a video camera, a personal digital device with an image capture module, and the like.

In one embodiment, the electronic device is detected by a sensor coupled to a network. For example, in one embodiment, the sensor is a cellular site coupled to a cellular network. In another embodiment, the sensor is a Bluetooth transmitter coupled to a local Bluetooth network. In yet another embodiment, the sensor is a Wi-Fi transmitter coupled to a Wi-Fi network.

In one embodiment, the electronic device is detected with a predetermined area such as a viewing area of The White House. In one instance, this predetermined area is customizable depending on the specific application. For example, a predetermined area with a view of the Golden Gate Bridge is predetermined by configuring the sensors to detect the electronic device.

In Block 620, the device type of the electronic device is detected. In one embodiment, different types of devices include cellular phones with image capture module, still cameras, video cameras, and the like.

In Block 630, the location of the device while capturing an image is monitored. In one embodiment, the sensor detects the location of the device when capturing the image by monitoring the device while within the predetermined area. For example, capturing the image by the device while the device is within the predetermined area is detected.

In one embodiment, the location of the device is monitored when the device captures the image. For example, the direction of the device is detected while the device is capturing the image. In one embodiment, the direction of the device is represented by minutes and seconds.

In Block 640, the subject matter of the image is determined. In one embodiment, the subject matter is determined based on the predetermined area that the device was located while capturing the image. In another embodiment, the subject mater of the image is determined also based on the direction of the device while capturing the image.

In Block 650, a unique identifier is broadcasted to the device based on the subject matter of the image. In one embodiment, the unique identifier is locally broadcasted through a network such as a Wi-Fi network, a blue tooth network, a cellular network, and the like. In one embodiment, the unique identifier corresponds with metadata information related to the captured image.

In one embodiment, the unique identifier is a reference number which corresponds to a particular record such as the record 400 that includes metadata information describing the subject matter of the captured image. In another embodiment, the unique identifier is a URL which corresponds to a unique address on the World Wide Web that includes metadata information describing the subject matter of the captured image.

In Block 660, the unique identifier is matched with corresponding metadata information describing the subject matter of the captured image. In one embodiment, the corresponding metadata information is stored at a location represented by a particular URL address and access through the World Wide Web. In another embodiment, the corresponding metadata information is contained within the storage module 330 and accessed through the interface module 340 via a reference number.

In one embodiment, matching the unique identifier with the corresponding metadata information is available through a paid service. For example, the unique identifier is matched with the corresponding metadata information through a third party. In one embodiment, payment for matching the unique identifier with the metadata information is made on a per match basis. In another embodiment, a monthly subscription is paid to match the unique identifier with the corresponding metadata information.

In Block 670, the metadata information describing the subject matter of the captured image is integrated with the captured image. In one embodiment, the metadata information corresponding to the captured image is stored with the captured image.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method comprising:
detecting a device within a predetermined area;
detecting an image captured by the device;
determining a subject of the image based on the predetermined area; and
broadcasting a signal to the device wherein the signal describes the subject of the image.

2. The method according to claim 1 further comprising detecting a direction of the device while capturing the image.

3. The method according to claim 2 wherein signal is based on the direction of the device.

4. The method according to claim 1 further comprising storing the signal within a storage module.

5. The method according to claim 1 wherein the signal includes metadata information corresponding to the subject of the image.

6. The method according to claim 5 wherein the metadata information includes background information of the subject.

7. The method according to claim 5 wherein the metadata information includes a key word describing the subject.

8. The method according to claim 5 wherein the metadata information includes advertising related to the subject.

9. The method according to claim 1 wherein the device is a camera.

10. The method according to claim 1 wherein the device is a cellular phone with an image capture module.

11. The method according to claim 1 wherein the device is a video camera.

12. The method according to claim 1 wherein the signal includes a unique identifier.

13. The method according to claim 12 further comprising matching the unique identifier with metadata information describing the subject.

14. The method according to claim 12 wherein the unique identifier is a URL.

15. A system comprising:
means for detecting a device within a predetermined area;
means for detecting an image captured by the device;
means for determining a subject of the image based on the predetermined area; and
means for broadcasting a signal to the device wherein the signal describes the subject of the image.

16. A method comprising:
detecting a device within a predetermined area;
detecting a direction of the device while capturing an image;
determining a subject of the image based on the predetermined area and the direction of the device while capturing the image; and
broadcasting a unique identifier to the device based on the subject of the image.

17. The method according to claim 16 wherein the unique identifier is a URL address.

18. The method according to claim 16 wherein the unique identifier is a string of characters.

19. The method according to claim 16 further comprising matching the unique identifier with metadata information describing the subject matter of the image.

20. The method according to claim 19 further comprising broadcasting the metadata information to the device.

21. The method according to claim 19 further comprising requesting a payment from the device prior to the matching the unique identifier.

22. The method according to claim 19 further comprising integrating the metadata information with the image.

23. The method according to claim 19 wherein the metadata information includes advertising.

24. The method according to claim 19 wherein the metadata information includes a key word describing the subject of the image.

25. A method comprising:
detecting a device within a predetermined area while capturing a captured image;
searching for a reference image;
comparing the reference image with the captured image;
determining a subject of the captured image based on comparing the reference image with the captured image; and
broadcasting information to the device based on the subject of the image.

26. The method according to claim 25 wherein the information includes metadata corresponding to the subject.

27. The method according to claim 25 wherein the information includes a unique identifier corresponding to the subject.

28. The method according to claim 25 further comprising selecting the reference image based on the predetermined area.

29. A system, comprising:
a recognition module for detecting a device;
a location module for detecting a location of the device while capturing a captured image;
a subject module for determining a subject of the captured image based on the location of the device; and
a storage module configured for storing information related to the subject of the captured image.

30. The system according to claim 29 wherein the information is metadata information describing the subject of the captured image.

31. The system according to claim 29 wherein the information is located at a URL address.

32. The system according to claim 29 further comprising an interface module for transmitting the information to the device.

33. A computer-readable medium having computer executable instructions for performing a method comprising:
detecting a device within a predetermined area;
detecting a direction of the device while capturing an image; and
determining a subject of the image based on the predetermined area and the direction of the device while capturing the image
broadcasting a unique identifier to the device based on the subject of the image.
